(19) United States
(12) Patent Application Publication
(10) Pub. No.: US 2008/0084688 A1
(43) Pub. Date: Apr. 10, 2008

(54) Helmet signal

(76) Inventor: Antonio White, Washington, DC (US)

Correspondence Address: Antonio Jerome White, 2813 B 4th St. NE, Washington, DC, 20002, US

(21) Appl. No.: 11/907,156

(22) Filed: Oct. 9, 2007

Related U.S. Application Data
(60) Provisional application No. 60/849,794, filed on Oct. 6, 2006.

(51) Int. Cl. F21V 21/084

(52) U.S. Cl. 362/105

(57) ABSTRACT

Signal indicating lights with a left turn right turn and hazard indicator lighting structure built into or attached to a cyclist helmet remotely controlled or automatically controlled through a cycle system. The remote comes three forms, a connection unit with that assembles to the cycle turn system. A wireless battery operated version with four indicator control buttons and a motorized electronically attached to a cycle with connection wires version.

### RELATED APPLICATION

The subject patent application claims priority under 35 U.S.C. § 119(e) from U.S. Provisional Patent Application Ser. No. 60/849,794 filed on Oct. 6, 2006 and is incorporated herein by reference.

### FIELD OF THE INVENTION

The present invention is directed to an indicator lighting system for use with bicycle and motorcycle helmets.

### BACKGROUND OF THE INVENTION

Safety is an important concern for most bicycle and motorcycle riders. Many states and localities already require helmet use by motorcycle riders and children. Many adults also wear helmets when riding their bicycle by choice. In an effort to be more visible, some bicycle riders have added a flashing light to their helmet, but motorcycle helmets and bicycle helmets are not currently manufactured with lighting systems built in and the supplemental lights for bicycle helmets are limited to a single flashing light. Therefore, it can be seen that there is a need for an improved lighting system for bicycle and motorcycle helmets to improve safety for riders.

### OBJECTS AND SUMMARY OF THE INVENTION

An object of the invention to provide a helmet signal system for use with motorcycle and bicycle helmets.

Another object of the invention is to provide a remote control switch system for a motorcycle and bicycle helmet lighting system.

Yet another object of the invention is to provide a signal system for helmets that can be installed on a helmet.

Still another object of the invention is to provide a signal system which can be installed during the manufacture of a helmet to create an integrated helmet and signal system.

Yet another object of the invention is to provide a handlebar mounted control system for operating the helmet signal system.

Still another object of the invention is to provide a remote control signal emitter in the handlebar mounted control system;

Yet another object of the invention is to provide a remote control signal receiver in the signal system attached to the helmet, and;

Another object of the invention is to provide a power source in the signal emitter and in the signal receiver for transmitting and receiving the remote control signal and for activating the light sources on the helmet.

In summary, the helmet signal system is a battery or electronically operated lighting indication system for a cyclist helmet, that when used can indicate a designated left turn, right turn, stop, or distress of a cyclist to motorist, pedestrians and other cyclist. The helmet signal system, functions with a battery or electronically operated, wireless handgrip remote control, attachable to the handgrip of a cycle, with a metal or plastic strap that wraps around the handgrip and tightens with a nut and bolt screw, from the side of the strap around the handle grip, back to the remote control unit. The helmet signal system may also function through the already existing turn control system on a motorized cycle. The indicator lights are attachable units to the cyclist helmet and can also be built into a helmet at construction with a wireless battery operated or electrical connection to a cycle's turn signal system or to the helmet signal's handle grip, depress style, press button remote control. The helmet signal system is created as an added safety feature for traditional cyclist helmets in that the added lighting feature that has been non-existent in traditional form will help save the lives of cyclist in case of accidents on and off public roads. The helmet signal system creates more visibility for the user's upper part of the body while riding. If the cyclist has fallen, the distress signal portion of the helmet signal system will alert oncoming traffic and pedestrians of an accident.

### BRIEF DESCRIPTION OF THE DRAWINGS

FIG. 1A shows a handlebar mounted remote control unit for a helmet mounted signal system.

FIG. 1B shows a front face of the remote control unit of FIG. 1.

FIG. 1C shows the back face of the remote control unit of FIG. 1.

FIG. 1D shows an alternative embodiment of the remote control unit.

FIG. 2A shows a preferred embodiment of indicator lights for use with a helmet attached signal system.

FIG. 2B shows an alternative embodiment of indicator lights for use with a helmet attached signal system.

FIG. 3A illustrates indicator lights attached to a helmet.

FIG. 3B illustrates the indicator light system of FIG. 3A built into a helmet.

FIG. 4A illustrates an alternative embodiment of an indicator light system attached to a helmet.

FIG. 4B illustrates the indicator light system of FIG. 4A built into a helmet.

FIG. 5A is front view of the helmet of FIG. 4B.

FIG. 5B is front view of the helmet of FIG. 3A.

### DETAILED DESCRIPTION OF THE INVENTION

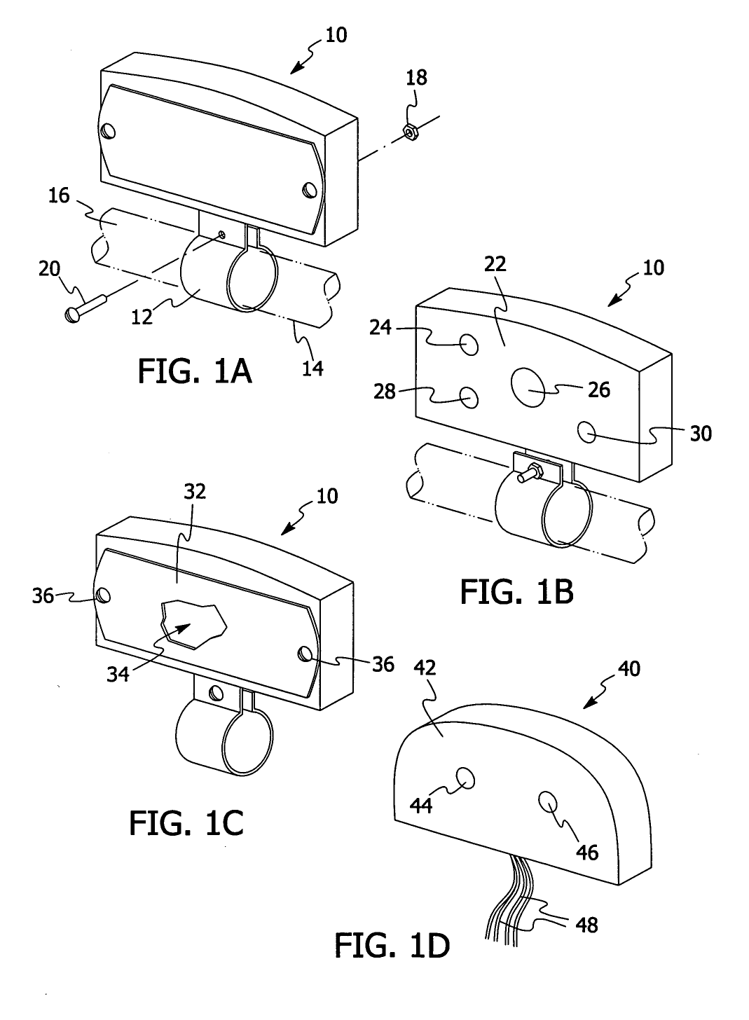

As shown in FIG. 1A is a battery operated wireless handgrip remote control unit 10 with a strap 12 formed preferably of steel, but may be formed of suitable plastic material that wraps around the hand grip 14 of a handlebar 16 and is connected preferably by a nut 18 and bolt 20. Preferably the control unit 10 is about a 1½×3½ inch rectangular curved shape box.

As shown in FIG. 1B is the front face 22 of the handgrip remote control unit 10, displaying four function buttons; on-off button 24, red hazard button 26, stop-pause button 28 and left turn-right turn button 30. Depressing the on-off button 24 once will turn on the unit 10 and depressing button 26 a second time will turn it off the unit 10. Depressing the left turn-right turn button 30 once indicates a left turn and depressing button 30 once again will turn it off. Depressing the button 30 twice indicates a right turn and depressing button 30 once again will turn it off.

Now looking to FIG. 1C, the back side 32 of control unit 10 is removeable to access the circuitry and battery compartment 34. The back side 32 is preferably retained by two removeable screws 36.

As shown in FIG. 1D, an alternative embodiment of a control unit 40 is shown having a face 42 having on-off 44 and distress 46 indicator buttons with connection wires 48 for connection to the wiring of a motorized cycle (not shown).

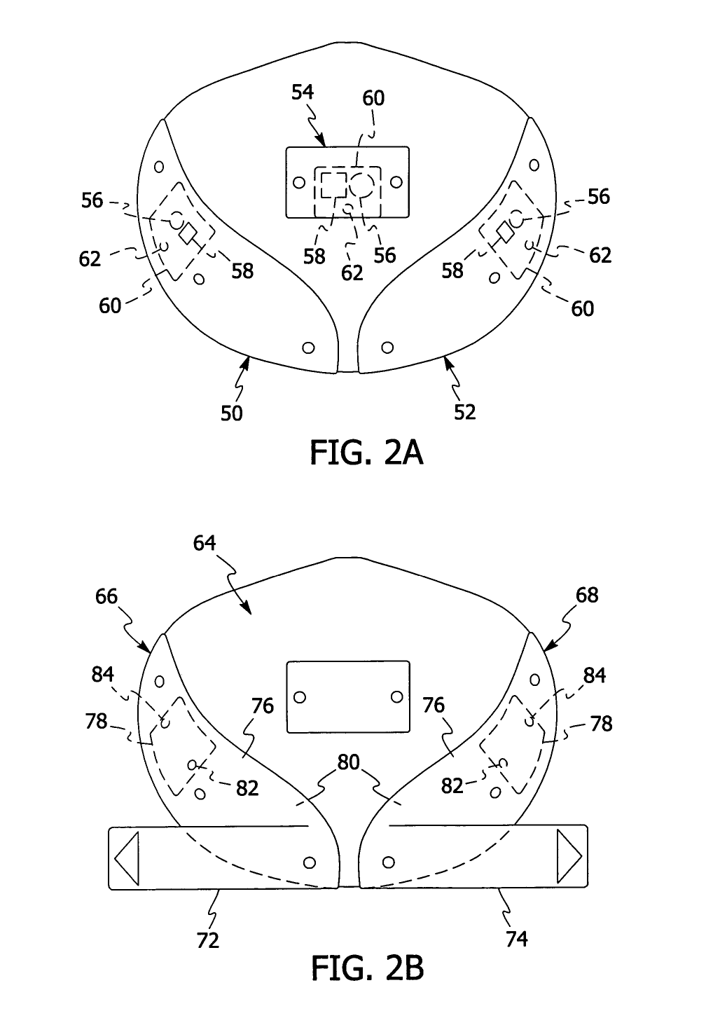

Now with reference to FIG. 2A, a left turn indicator light 50, a right turn indicator light 52 and a center indicator light 54 are shown. The indicator lights 50, 52, and 54 may be separated and wirelessly operated and can be either attachable, i.e. purchased as a kit and installed onto an existing helmet or built into a helmet during its manufacture. If each indicator light 50, 52, and 54 is separate and wirelessly operated then each light requires a power source such as a battery 56 and wireless signal receiver 58. The battery 56 is preferably retained within a cover 60 which is attached by either a friction fit or by screws 62.

Now with reference to FIG. 2B, the indicator lights 64 include a left light 66 and right light 68 which are separated and wireless and can either be attachable or built into the helmet 70 during manufacture. The left and right indicator lights 66 and 68, respectively preferably include an approximately 3½ inch extended section 72 and 74. The indicator lights 66 and 68 further preferably include a cover 76 to enclose wireless circuitry, light bulbs and battery compartment. An access plate 78 is preferably located on the bottom 80 for access to the battery and the plate 78 can be held in place by two screws 82 and 84 or other suitable connection means.

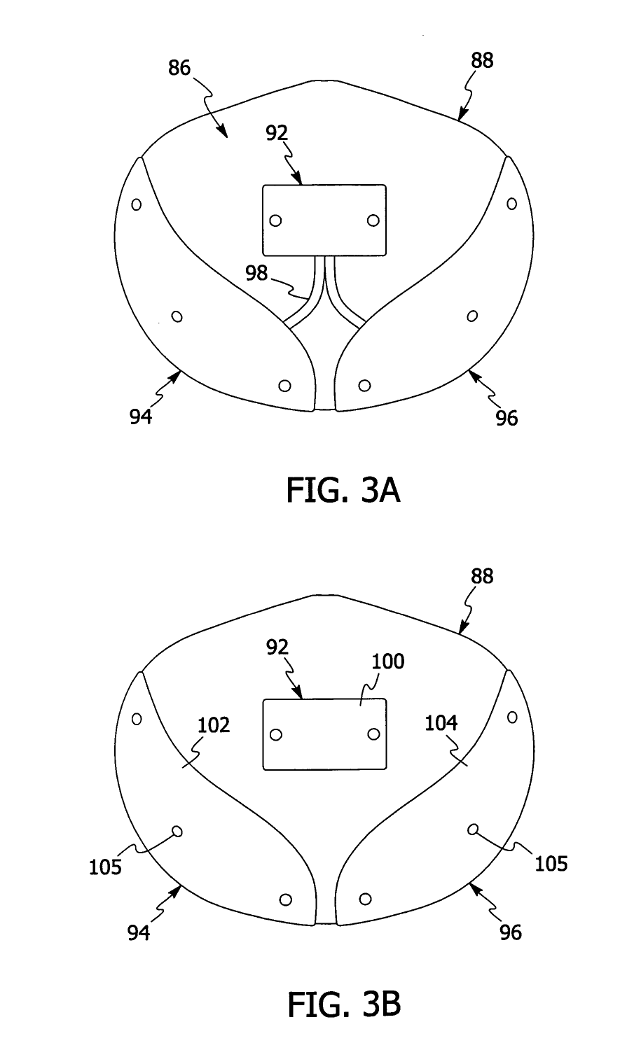

FIG. 3A illustrates a rear view of indicator lights 86 attached to a wrap-around helmet 88 and includes indicator lights 92, 94 and 96 connected by a electronic connector 98 such as a wire. In this embodiment, one of the indicator lights 92, 94 and 96 would include a power source (not shown) such as a battery, and a wireless signal receiver (not shown) which would activate the indicator lights 92, 94 and 96.

FIG. 3B illustrates the embodiment of FIG. 3A when the indicator lights 92, 94 and 96 are built with the helmet 88 as a unit. Each of the indicator lights 92, 94 and 96 are preferably accessible by removing its respective cover 100, 102 and 104 which may be attached by screws 105 or other suitable means. The indicator lights 92, 94 and 96 are preferably electronically connected by a suitable conductor such as a wire (not shown) which would be inside the shell of the helmet 88.

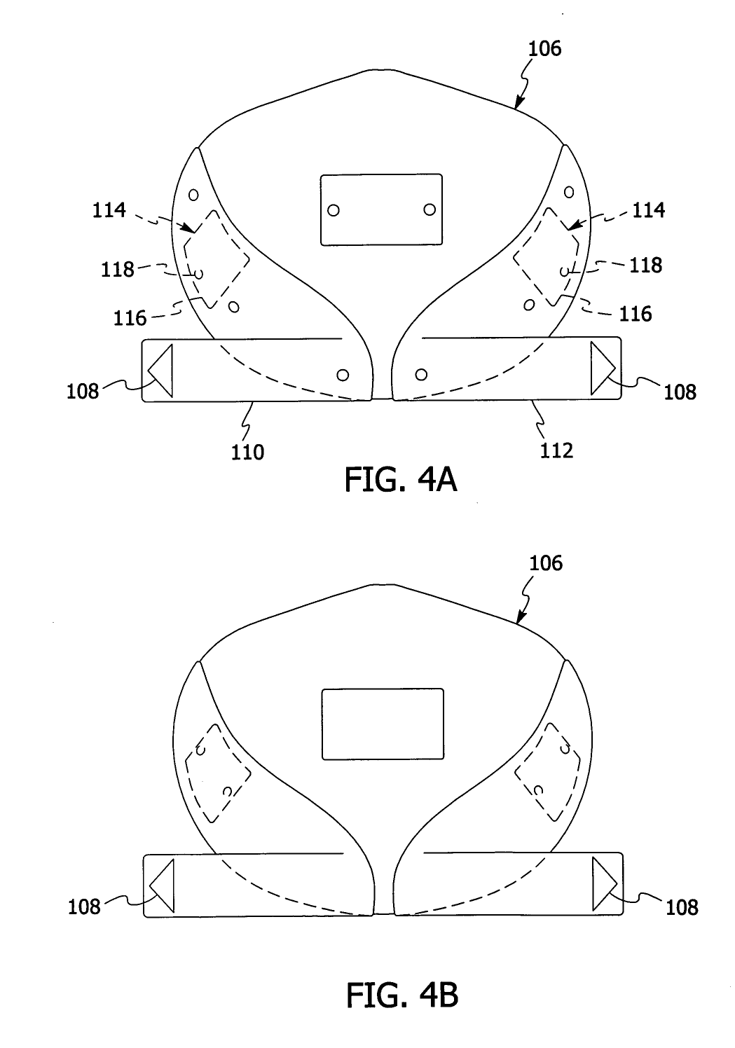

FIG. 4A is a rear view of a helmet 106 having an indicator light 108 shown with an optional approximately 3½ inch extended section attached to the left and right rear sections 110 and 112, respectively of the indicator light 108 with a compartment 114 for retaining wireless circuitry, light bulb change and a power source. A removeable cover 116 is located over the compartment 114 for permitting access thereto and may be attached by a suitable attachment devices such as screws 118.

FIG. 4B is a rear view of the helmet 106 having the integrated indicator light 108 built into the helmet.

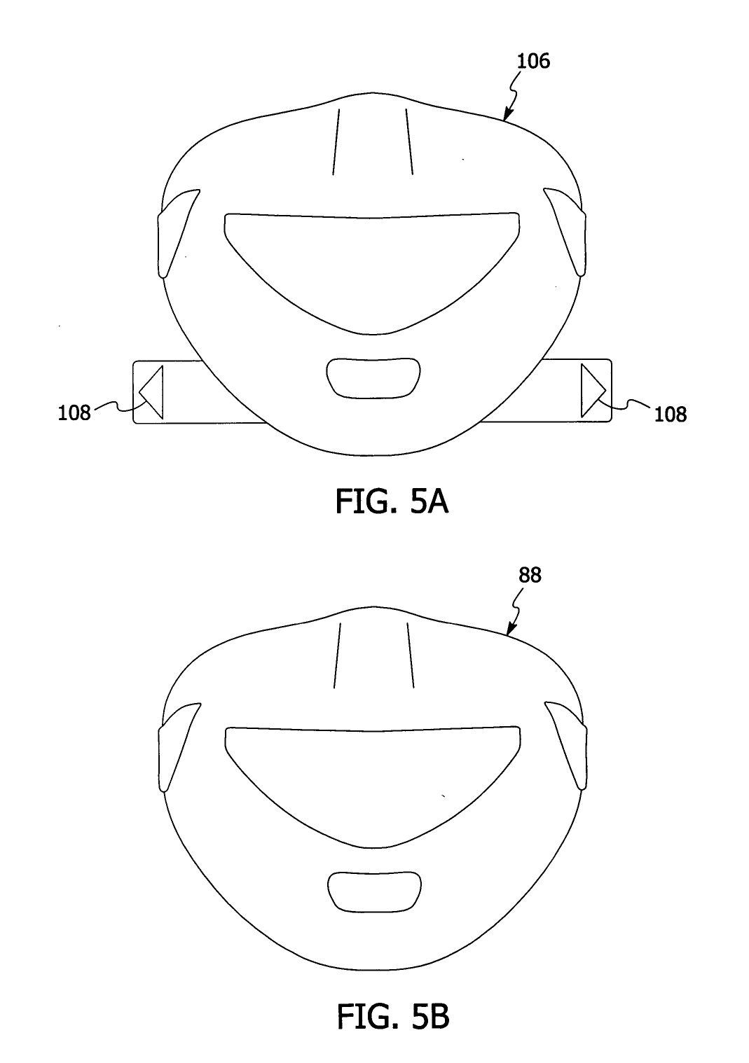

FIG. 5A is the front view of the helmet 106 having the integrated indicator light 108.

FIG. 5B shows the front view of the helmet 88.

While the foregoing lighting systems have been described as preferably being used with a wireless transmitter, it should be understood that a wired system may also be used.

While this invention has been described as having a preferred design, it is understood that it is capable of further modifications, uses and/or adaptations of the invention following in general the principle of the invention and including such departures from the present disclosure as come within the known or customary practice in the art to which the invention pertains and as maybe applied to the central features hereinbefore set forth, and fall within the scope of the invention and the limits of the appended claims.

I claim:

1. A lighted indicator system for a helmet comprising:
a) a control box having an attachment device for connecting said control box to a vehicle;
b) a turn indicator apparatus adapted for attachment to a helmet for indicating at least right and left turns;
c) said control box having signal actuation devices for operating said turn indicator system attached to a helmet.

2. The lighted indicator system as set forth in claim 1, wherein:
a) said signal actuation devices include buttons which operate when depressed.

3. The lighted indicator system as set forth in claim 1, wherein:
a) said control box includes a transmitter for emitting a radio signal,
b) said turn indicator apparatus includes a radio signal receiver for receiving said radio signal,
c) whereupon, operation of said signal actuation devices causes said turn indicator apparatus to operate to indicate a right or left turn.

4. The lighted indicator system as set forth in claim 3, wherein:
a) when said turn indicator apparatus operates to indicate a right or left turn, a light associated with said turn indicator apparatus flashes on and off.

5. The lighted indicator system as set forth in claim 1, wherein:
a) said attachment device for said control box includes a strap adapted to engage a handlebar of a motorcycle or a bicycle.

6. The lighted indicator system as set forth in claim 1, wherein:
a) said control box includes an electric power source.

7. The lighted indicator system as set forth in claim 6, wherein:
a) said electric power source is a battery.

8. The lighted indicator system as set forth in claim 6, wherein:
a) said electric power source is an electrical system of a vehicle.

9. The lighted indicator system as set forth in claim 1, wherein:
a) said turn indicator apparatus includes a left turn indicator and a right turn indicator, wherein each of said right and left turn indicators operate independently.

10. The lighted indicator system as set forth in claim 9, wherein:
a) said turn indicator apparatus further includes a stop light.

11. The lighted indicator system as set forth in claim 1, wherein:
a) said turn indicator apparatus includes a left turn indicator and a right turn indicator, wherein each of said right and left turn indicators operate independently, and
b) each of said left turn indicator and said right turn indicator includes a portion extending outwardly from the helmet.

12. A helmet having a lighted turn indicator apparatus for use when riding a motorcycle or bicycle for indicating left and right turns, comprising:
a) a shell forming a protective head covering;
b) said shell including a light apparatus thereon having a plurality of lights for indicating left and right turns;
c) said lights being electronically connected to a power source retained on said shell;
d) said shell further including a signal receiver for use in operating said light apparatus.

13. The helmet having a lighted turn indicator apparatus for use when riding a motorcycle or bicycle for indicating left and right turns as set forth in claim 12, further comprising:
a) an emergency activation device which causes a light on said light apparatus to flash when activated.

14. The helmet having a lighted turn indicator apparatus for use when riding a motorcycle or bicycle for indicating left and right turns as set forth in claim 12, further comprising:
a) said turn indicator apparatus includes a left turn indicator and a right turn indicator, wherein each of said right and left turn indicators operate independently, and
b) each of said left turn indicator and said right turn indicator includes a portion extending outwardly from the helmet.
